(19) United States
(12) Patent Application Publication
(10) Pub. No.: US 2026/0039219 A1
(43) Pub. Date: Feb. 5, 2026

(54) POWER CONVERTER AND CAPACITOR VOLTAGE BALANCE

(71) Applicant: Infineon Technologies Austria AG, Villach (AT)

(72) Inventor: Pablo ELOSEGUI GARCIA, Villach (AT)

(21) Appl. No.: 18/794,247

(22) Filed: Aug. 5, 2024

(51) Int. Cl. H02M 7/04; H02M 7/25

(52) U.S. Cl. CPC H02M 7/05; H02M 7/25

(57) ABSTRACT

A power converter assembly as discussed herein can be configured to include a controller. The controller is operative to: control delivery of input current from an input voltage source to a resonant power converter; monitor a first voltage (Vsplit) at a first node of the resonant power converter, the first node coupling a first capacitor and a second capacitor in series; and adjust a magnitude of the input current supplied from the input voltage source to the resonant power converter based upon the monitored first voltage.

### BACKGROUND

Power converters have long been used to convert a respective input voltage into an output voltage to power a corresponding load. In certain instances, the input voltage is an alternating voltage (AC voltage) while the output voltage is a DC voltage. One type of power converter topology implements a so-called Auxiliary Commutated Pole, where the voltage between the split-capacitors used for the resonance of the pole may deviate from a nominal value. Conventional techniques include implementing parallel resistors to provide capacitor voltage balancing.

### BRIEF DESCRIPTION

Implementation of clean energy (or green technology) is important to reduce our impact as humans on the environment. In general, clean energy includes any evolving methods and materials to reduce an overall toxicity on the environment from energy consumption.

This disclosure includes the observation that raw energy, such as received from green energy sources or non-green energy sources, typically needs to be converted into an appropriate form (such as desired AC voltage, DC voltage, etc.) before it can be used to power end devices such as servers, computers, mobile communication devices, wireless base stations, etc. In certain instances, energy is stored in a respective one or more battery resource. Alternatively, energy is received from a voltage generator. Regardless of whether energy is received from green energy sources or non-green energy sources, it is desirable to make most efficient use of raw energy (such as storage and subsequent distribution) provided by such systems to reduce our impact on the environment. This disclosure contributes to reducing our carbon footprint and better use of energy via more efficient energy conversion.

A voltage node connecting split-capacitors in a conventional power converter may support resonance associated with an Auxiliary Commutated Pole and may deviate from a nominal value. This disclosure includes the observation that it is desirable to balance capacitor voltages in a power converter topologies implementing an Auxiliary Commutated Pole without extra hardware components or complex switching of output switches.

A controller as discussed herein can be configured to control operation of a power converter. For example, the controller can be configured to control delivery of input current from an input voltage source to a resonant power converter. The controller monitors a first voltage (such as so-called Vsplit) at a first node (such as split capacitor node) of the resonant power converter. The first node may provide coupling between a first capacitor and a second capacitor of the resonant power converter in series. During operation, the controller may adjust a magnitude of the input current supplied from the input voltage source to the resonant power converter based upon a magnitude of the monitored first voltage.

In one example, via the adjusted magnitude of the input current, the controller may regulate a magnitude of the first voltage at the split capacitor node. Regulation may include the controller controlling operation of first switches. The controlled operation of the first switches may further include controlling supply of the input current through an inductor of the resonant power converter.

Yet further, note that the first capacitor may be directly connected between the first node and a second node of the resonant power converter; the second capacitor may be directly connected between the first node and a third node of the resonant power converter. The controller can be configured to control the magnitude of the input current to maintain the magnitude of the first voltage within a desired voltage range.

In one example, the first capacitor as discussed herein may store a first capacitor voltage; the second capacitor as discussed herein may store a second capacitor voltage. In such an instance, the controller can be configured to adjust the magnitude of the input current from the input voltage source as supplied to the resonant power converter such that a magnitude of the first capacitor voltage is substantially equal to a magnitude of the second capacitor voltage. It is further noted that the resonant power converter can be configured to output an output voltage from a combination of the second node and the third node. In such an instance, the controller adjusting the magnitude of the input current may maintain a magnitude of the first voltage to be substantially half the magnitude of the output voltage.

Yet further examples as discussed herein include the input current being an AC input current supplied by the input voltage source (a.k.a., input current source) to the resonant power converter; the resonant power converter can be configured to convert the AC input current into a DC output voltage.

Still further, note that the controller as discussed herein can be configured to adjust pulse width modulation control signals supplied to high side switch circuitry and low side switch circuitry of the resonant power converter to control the magnitude of the input current.

In one example, in response to detecting that a magnitude of the first voltage is above a threshold level, the controller can be configured to operate the resonant power converter in a first mode of: i) reducing a first duty cycle of operating the first switch circuitry, and ii) increasing a second duty cycle of operating the second switch circuitry, where operation in the first mode reduces the magnitude of the first voltage.

Conversely, in response to detecting that a magnitude of the first voltage is below a threshold level, the controller can be configured to operate the resonant power converter in a second mode of: i) increasing a first duty cycle of operating the first switch circuitry, and ii) decreasing a second duty cycle of operating the second switch circuitry, where operation in the second mode increases the magnitude of the first voltage. Implementation of the different operational modes such as the first mode and the second mode cause the voltage on the first capacitor to be substantially equal to the voltage on the second capacitor.

Yet further examples as discussed herein include the controller decreasing an average magnitude of the input current in response to detecting that the magnitude of the first voltage is above a threshold level. Conversely, the controller can be configured to increase an average magnitude of the input current in response to detecting that the magnitude of the first voltage is below a threshold level.

Further, the controller as discussed herein also can be configured to receive an error voltage indicating a difference between the magnitude of the first voltage (Vsplit) and a setpoint reference voltage. The controller can be configured to adjust the magnitude of the input current supplied from the input voltage source to the resonant power converter based on a magnitude of the error voltage.

In another example, the controller as discussed herein can be configured to receive an error value indicating a difference between a magnitude of the first voltage and a setpoint reference value; implement a lookup table or equation to convert the error value into an adjustment value; and adjust the magnitude of the input current based upon the adjustment value. As previously discussed, the adjustment to the input current biases a magnitude of the monitored voltage Vsplit to substantially half the output voltage.

As previously discussed, adjustment of the input current can be implemented in any suitable manner. In one example, the controller can be configured to implement a summer function to adjust a reference current value via the adjustment value. In such an instance, the controller can be configured to use the adjusted reference current value as a basis to adjust the magnitude of the input current. Alternatively, the controller can be configured to implement a multiplier function to adjust a reference current value via the adjusted value. The controller can be configured to use the adjusted reference current value as a basis to adjust the magnitude of the input current.

Yet further, examples herein include an apparatus comprising the controller. As previously discussed, the controller can be configured to: control delivery of input current from an input voltage source to a resonant power converter; monitor a first voltage (Vsplit) at a first node of the resonant power converter, the first node coupling a first capacitor and a second capacitor in series; and adjust a magnitude of the input current supplied from the input voltage source to the resonant power converter based upon the monitored first voltage.

Additionally, note that although examples as discussed herein are applicable to controlling operation of a resonant power converter and supporting capacitor voltage balancing, the concepts disclosed herein may be advantageously applied to any other suitable topologies as well as general power supply control applications.

The ordering of the steps above has been added for clarity sake. Note that any of the processing operations as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be implemented strictly as a software program, firmware, as a hybrid of software, hardware and/or firmware, or as hardware alone such as within a processor (hardware or software), or within an operating system or a within a software application.

As discussed herein, techniques herein are well suited for use in the field of implementing one or more power converters to deliver current to a load. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be implemented and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram of a power converter as discussed herein.

FIG. 2 is an example timing diagram of controlling a power converter as discussed herein.

FIG. 3 is an example timing diagram illustrating standard operation of a power converter versus adjustment of input current to regulate operation of a power converter as discussed herein.

FIG. 4 is an example diagram illustrating adjustment of a reference current value to regulate an intermediate voltage of the power converter as discussed herein.

FIG. 5 is an example timing diagram illustrating a first method (amplitude modulation adjustment) associated with adjusting input current to a power converter to regulate split capacitor voltages as discussed herein.

FIG. 6 is a timing diagram illustrating pulse width modulation adjustments during an overvoltage condition to provide regulation of an intermediate voltage (such as split capacitor voltage Vsplit) as discussed herein.

FIG. 7 is a timing diagram illustrating pulse width modulation adjustments during an undervoltage condition to provide regulation of an intermediate voltage (such as split capacitor voltage Vsplt) as discussed herein.

FIG. 8 is an example diagram illustrating offset adjustment of a reference current value to regulate the power converter as discussed herein.

FIG. 9 is an example timing diagram illustrating a second method (DC offset adjustment) of adjusting input current to a power converter to regulate a respective capacitor voltage as discussed herein.

FIG. 10 is an example diagram illustrating a voltage range in which an intermediate voltage (such as voltage Vsplit) is maintained as discussed herein.

FIG. 11 is an example diagram illustrating a computer architecture to execute any of the operations as discussed herein.

FIG. 12 is an example method as discussed herein.

FIG. 13 is an example diagram illustrating detection of the intermediate voltage (such as voltage Vsplit) being out of range as discussed herein.

FIG. 14 is an example circuit diagram illustrating implementation of a power converter as discussed herein.

FIG. 15 is an example circuit diagram illustrating implementation of a power converter as discussed herein.

FIG. 16 is an example circuit diagram illustrating implementation of a power converter as discussed herein. The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

As further discussed herein, a power converter controller (such as apparatus, circuit, hardware, etc.) can be configured to control delivery of input current from an input voltage source to a resonant power converter based on monitoring a first voltage (such as voltage Vsplit) measured at a node of the resonant power converter. The node can be configured to couple a first capacitor and a second capacitor in series. Based upon the monitored first voltage Vsplit, the power converter controller adjusts a magnitude of the input current supplied from the input voltage source to the resonant power converter. In one example, the adjusted magnitude of the input current provides regulation of the first voltage and corresponding substantial equalization of a magnitude of a voltage across the first capacitor and a magnitude of a voltage across the second capacitor.

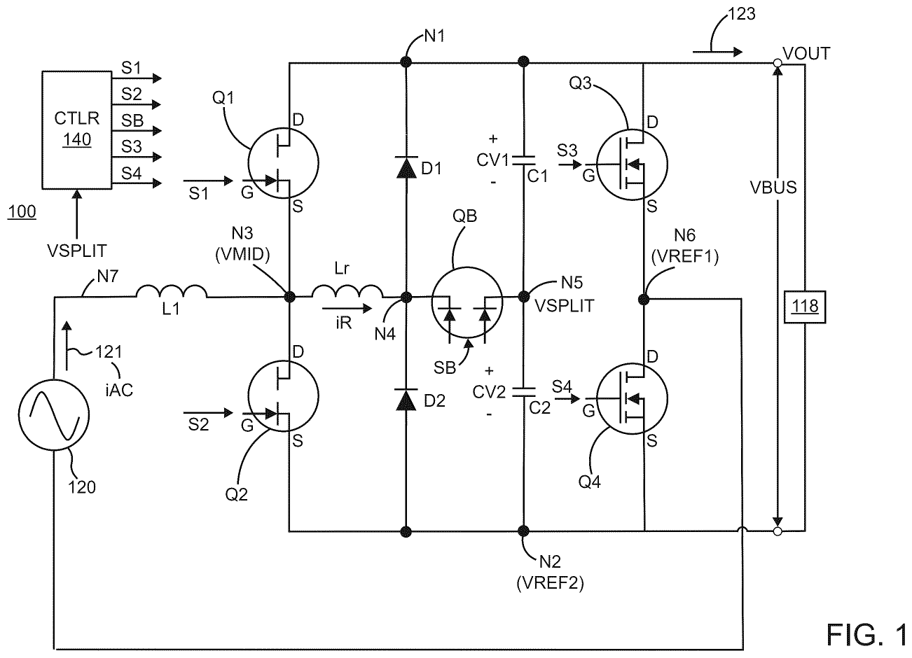

Now, more specifically, FIG. 1 is an example diagram of a power converter as discussed herein.

In this general example, the power converter 100 (circuitry, apparatus, hardware, power supply, etc.) includes controller 140, input voltage source 120 (a.k.a., input current source), inductor L1, switch Q1, switch Q2, inductor LR, bidirectional switch QB, capacitor C1, capacitor C2, switch Q3, and switch Q4.

The voltage source 120 (such as an AC voltage source alternating between providing a positive and negative input current) is directly connected between node N6 and node N7. The inductor L1 is directly connected between node N7 and node N3. Input current 121 flows through the inductor L1.

Switch Q1 and switch Q2 are connected in series between the node N1 and node N2 via connectivity provided by node N3. The voltage at node N3 is Vmid.

In one example, each of the switches Q1 and Q2 are fabricated as GaN (Gallium Nitrite) field effect transistors or SiC (Silicon Carbide) field effect transistors, although such switches can be fabricated in accordance with any suitable technology.

Inductor LR is connected between node N3 and node N4.

Diode D1 and diode D2 are connected in series between node N1 and node N2 via connectivity provided by node N4. Current iR flows through the inductor LR.

Bidirectional switch QB is connected between node N4 and node N5. Thus, the operational state of the switch QB controls flow of current between node N4 and node N5. In one example, the bidirectional switch QB is fabricated as a GaN (Gallium Nitrite) field effect transistor, although such a switch can be fabricated in accordance with any suitable technology.

Capacitor C1 and capacitor C2 are connected in series between node N1 and node N2 via connectivity provided by node N5. The voltage at node N5 with respect to the node N2 (a.k.a., VREF2) is Vsplit. The voltage at node N1 with respect to the node N2 is output voltage 123 or voltage Vbus. The output voltage may provide power to a respective load 118.

Yet further, switch Q3 and switch Q4 are connected in series between the node N1 and node N2 via connectivity provided by node N6. The voltage at node N6 is VREF1. As previously discussed, the input voltage source 120 (input current source) is also connected to node N6, referencing the input voltage source 120 to the reference voltage VREF1 at node N6.

In FIG. 1, note that G=gate node, S=source node, and D=drain node.

In one example, each of the switches Q3 and Q4 are fabricated as Silicon (Si) field effect transistors, although such switches can be fabricated in accordance with any suitable technology.

In one example, as previously discussed, the voltage source 120 is an AC (Alternating Current) voltage source supplying an alternating input voltage and corresponding alternating current 121 (iAC or AC current or Alternating Current) through the inductor L1 to the node N3.

The output voltage 123 (a.k.a., Vbus) may be a substantially DC (Direct Current) voltage with some amount of AC ripple.

As previously discussed, in an Auxiliary Commutated Pole, the voltage Vsplit such as at node N5 between the split-capacitors (C1 and C2) supporting the resonance of the pole can deviate from a nominal value such as Vbus/2. It is desirable to balance the magnitude of the voltage Vsplit at node N5 such that the voltage the split between the capacitor C1 and C2 is equal to Vbus/2 or, said differently, that the magnitude of the voltage across the capacitor C1 is substantially the same as the magnitude of the voltage across capacitor C2. It is further desirable to achieve this balance without implementing extra hardware components or complex switching of switches controlling the pole (such as including switches Q3 and switch Q4).

In this example, such as a totem pole PFC (Power Factor Correction) topology, an Auxiliary Commutated Pole can be used to achieve Zero Voltage Switching (ZVS) even in a Continuous Current Mode (CCM). The pole in this example is connected at the mid-point (N5) between the two switching devices (switches Q3 and Q4) of the fast-switching leg (higher frequency switching like).

Note further that an AC ripple associated with the voltage Vsplit at node N5 may vary (frequency of ripple voltage associated with Vsplit) at the same frequency as the frequency of the input current 121. For input conditions and output conditions (voltage, current) remaining the same, the average input current 121 for a positive half of the cycle is generally equal to the average of the current for negative half of the cycle. In such an instance, the voltage Vsplit will generally revert back to a voltage magnitude after each AC cycle of the input voltage source 120 supplying the corresponding input voltage and corresponding input current 121. As previously discussed, the magnitude of the voltage Vsplit at node N5 is ideally Vbus divided by 2 or the suitable setpoint.

In one example, there is a maximum deviation of the voltage, ΔV, which changes depending on the output power.

It is further noted that the input voltage or corresponding input current 121 supplied by the source 120 may be interrupted or experience abnormal conditions such that the balance of power or energy supplied by the input voltage source 120 to the corresponding resonant power converter 100 is not balanced between positive and negative portions of one or more cycles. During abnormal conditions such as due to line cycle drop-out (dropout of input current 121) or load jumps (increased or decreased current consumption by the load 118), without addressing such fault conditions, the voltage Vsplit at node N5 can further deviate from the allowed maximum or minimum magnitudes. This may happen when more total power is transferred in the positive half-cycle of the input current 121 cycle than the negative half-cycle of the input current 121 or vice-versa.

To address this imbalance issue (such as the magnitude of voltage CV1 across the capacitor C1 being different than the voltage CV2 across the capacitor C2), via generation of the signals S1, S2, SB, S3, and S4, the controller 140 controls the operation of the respective switches Q1, Q2, QB, Q3, and Q4 to maintain a magnitude of the voltage Vsplit within a desired range.

More specifically, via control of the switches Q1 and Q2 on the input side of the power converter 100, the controller 140 controls delivery of the input current 121 from the input voltage source 120 supplied to the inductor L1 of the power converter 100. Thus, the input current 121 may be inputted to the power converter 100 (such as a resonant power converter) through the inductor L1.

As further shown, the controller 140 monitors voltage Vsplit (feedback) received from node N5 of the resonant power converter 100. As previously discussed, the node N5 couples the capacitor C1 and capacitor C2 of the power converter 100 in series. Based on a magnitude of the monitored voltage Vsplit, the controller 140 controls the operation of switches Q1 (such as high-side switch circuitry) and Q2 (such as low side switch circuitry), thereby adjusting a magnitude of the input current 121 (iAC) supplied from the input voltage source 120 to the (resonant) power converter 100.

In one example, as further discussed herein, adjustment of the magnitude of the input current 121 includes control of the first switches (Q1 and Q2) at an input of the resonant power converter 100 through inductor L1. The adjusted magnitude of the input current 121 supplied to the inductor L1 can be used to regulate a magnitude of the voltage Vsplit with respect to a desired setpoint voltage or regulates the magnitude of the voltage Vsplit or average magnitude of the voltage Vsplit to fall within a desired range.

As previously discussed, the first capacitor C1 can be configured to store a first capacitor voltage CV1; the second capacitor C2 can be configured to store a second capacitor voltage CV2.

In one example, via control of respective switches Q1 and Q2, the controller 141 adjusts the magnitude of the input current 121 from the input voltage source 120 to the resonant power converter 100 such that a magnitude of the first capacitor voltage CV1 is substantially equal to a magnitude of the second capacitor voltage CV2.

Accordingly, the resonant power converter 100 as discussed herein can be configured to output an output voltage Vbus from a combination of the node N1 and the node N2. The adjustment of the magnitude of the input current 121 as further discussed herein maintains a magnitude of the voltage Vsplit to be substantially half the magnitude of the output voltage Vbus (output voltage 123) or other suitable value.

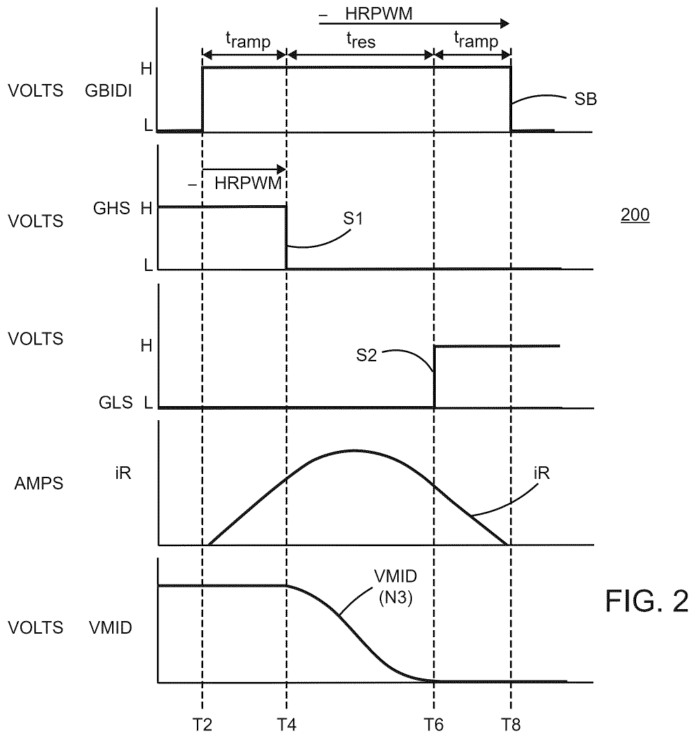

FIG. 2 is an example timing diagram of controlling a power converter as discussed herein.

Timing diagram 200 illustrates operation of the switches in the resonant power converter 100 to convert the input voltage and corresponding input current 121 supplied by the input voltage source 120 into a respective output voltage Vout (Vbus) outputted from a combination of node N1 and the node N2.

As shown in timing diagram 200, the controller 140 controls operation of the respective switches Q1, Q2, and QB in the resonant power converter 100 via signals S1, S2, and SB. For example, between time T2 and time T8, the controller 140 produces the control input SB (such as one or more control signals) to activate the switch QB to an ON-state. This results in flow of current iR through the inductor Lr. The amount of current flow is contingent upon operation of switches Q1 and Q2.

The flow of current iR ramps up between time T2 and time T4 based on activation of the switch Q1 (signal S1 is a high state) and activation of switch QB (signal SB is high). In such an instance, while the switch Q2 is also off (signal S2 is in a low state) between time T2 and time T4, the input current 121 flows through the inductor L1 and the switch Q1 (on state) to the node N1 as well as flows through the inductor LR and switch QB.

Between time T4 and time T6, both switches Q1 and Q2 are set to an off state (both signal S1 and signal S2 are in a low state). In such an instance, the current iR flows through inductor L1, inductor LR, and the switch QB to the node N5, resulting in resonance with the capacitors C1 and C2.

The flow of current iR through the inductor LR ramps down between time T6 and time T8 based on activation of the switch Q2 (signal S2 is in a high state) and activation of switch QB (signal SB is high) and deactivation of the switch Q1 (signal S1 is in a low state). In such an instance, between time T6 and time T8, the input current 121 flows through the inductor L1 and the switch Q2 to the node N2 as well as flows through the inductor LR and switch QB.

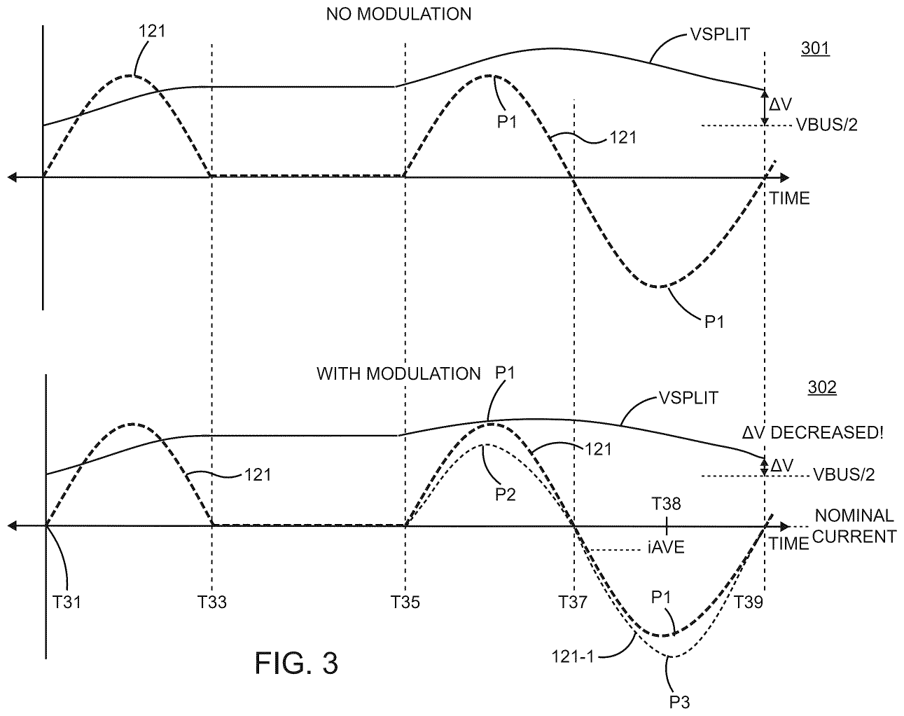

FIG. 3 is an example timing diagram illustrating adjustment of input current to regulate operation of a power converter as discussed herein.

In this example, timing diagram 301 illustrates how a magnitude of the voltage Vsplit at node N5 increases during a failure condition in which there is a dropout in the input current 121 (e.g., a magnitude of the input voltage and input current 121 supplied by the input voltage source 120 is zero or other amount during the negative cycle between time T33 and time T35).

As previously discussed, it is desirable to maintain the magnitude of the voltage Vsplit at a magnitude of Vbus/2 even when the input current 121 supplied by the input voltage source 120 experiences a respective outage or possible overvoltage or undervoltage. The lack of or improper amount of negative current (input current 121) supplied by the voltage source 120 through the inductor L1 between time T33 and time T35 causes the voltage Vsplit to undesirably rise above a respective threshold level. In other words, because the proper amount of negative current (input current 121) is not provided by the input voltage source 120 between time T33 and time T35, the magnitude of the voltage Vsplit undesirably increases above Vbus/2 via conventional circuits.

As shown in timing diagram 302, and as previously discussed, via operation of the respective switches Q1 and Q2 and variation of corresponding turn on times as well as control of other switches in the power converter 100, the controller 140 can be configured to adjust the corresponding magnitude of input current 121 supplied by the voltage source 120 through the inductor L1 such that the magnitude of the voltage Vsplit is substantially equal to Vbus/2.

More specifically, as shown in timing diagram 302, in response to detecting that the magnitude of the feedback voltage Vsplit falls out of a desired range or is above a threshold level Vbus/2, the controller 140 can be configured to adjust operation of the respective switches Q1 and Q2 via implementation of modulation.

In this example, as further discussed herein, the modulation of the input current 121 as implemented by the controller 140 includes adjusting a shape (magnitude of the input current over time) and a corresponding peak magnitude P1 of the positive current 121 supplied by the input voltage source 120 through the inductor L1 during the positive cycle between time T35 and time T37 to be P2 which is lower than the normal setting of P1 and nominal amount of input current 121 that would otherwise be supplied through the inductor L1 if there were no failure between time T33 and time T35. In other words, as shown, the adjusted positive peak amplitude P2 associated with the adjusted input current 121-1 is less than the positive peak amplitude P1 associated with the nominal input current 121. Thus, as further discussed herein, in response to detecting that there is an overvoltage condition associated with the monitored voltage Vsplit, techniques herein include reducing the average amount of input current 121 to maintain the magnitude of the voltage Vsplit within regulation. In this example, the actual magnitude of the input current 121-1 in the range T35 to T37 is less than the magnitude of the otherwise nominal input current 121 at every point between time T35 and time T37.

Additionally, in this example, the modulation implemented by the controller 140 includes adjusting an overall shape of the magnitude of the input current 121-1 between time T37 and time T39 including adjustment of a negative peak magnitude −P1 (nominal negative P) of the negative current 121 supplied by the input voltage source 120 during the negative cycle of the input voltage source 120 supplying negative current 121 to the inductor Lr between time T37 and time T39 to be −P3, which is greater in magnitude (backup negative) than the nominal or normal negative peak −P1 associated with the nominal input current 121 at time T38. In fact, the magnitude of the input current 121-1 in the range T37 to T39 is greater than the magnitude of the otherwise nominal input current 121 at every point between time T37 and time T39.

Thus, the average magnitude of input current 121 is lowered or reduced by the controller 140 between time T35 and time T39 with respect to the nominal current threshold (zero) to maintain the magnitude of the voltage Vsplit within a desired that range.

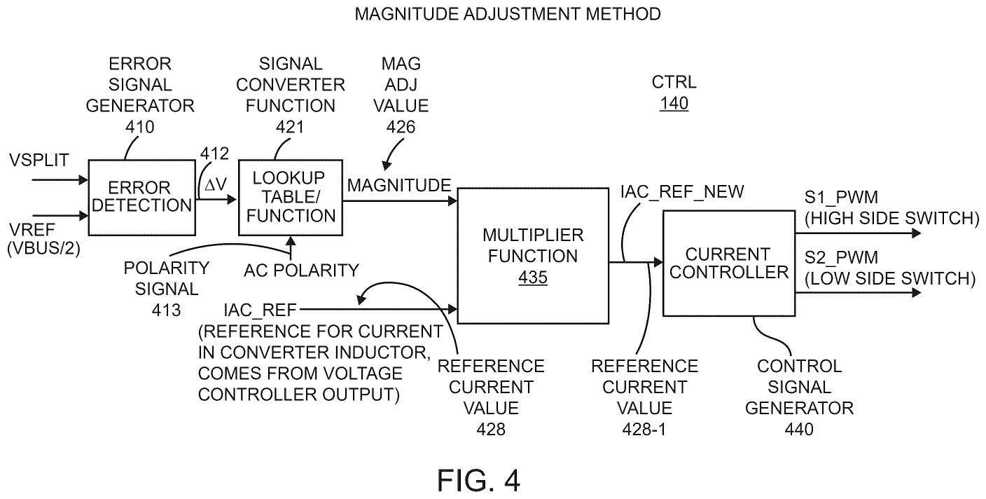

FIG. 4 is an example diagram illustrating magnitude adjustment of a reference current value to regulate the power converter as discussed herein.

In this example, the controller 140 includes error signal generator 410, signal converter function 421, multiplier function 435, and PWM (Pulse Width Modulation) signal generator 440.

As shown, the error signal generator 410 can be configured to receive the voltage Vsplit generated at the node N5. Additionally, the error signal generator 410 receives the setpoint reference voltage Vref (such as Vbus/2 or other suitable value).

The error signal generator 410 (such as error detection circuitry) produces the respective error signal 412 indicating a respective difference (such as Vref−Vsplit) between the magnitude of the voltage Vsplit and the magnitude of the setpoint reference voltage Vref. The error signal generator 410 outputs the error signal 412 to the signal converter function 421.

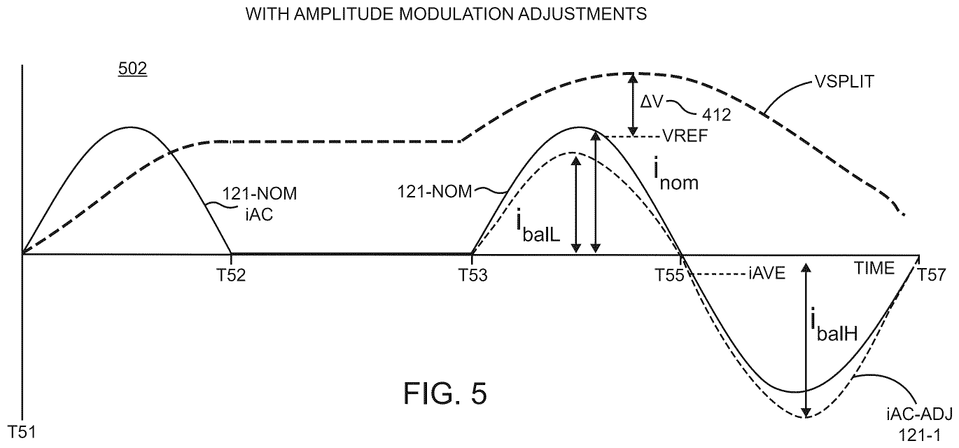

As previously discussed, the input voltage and corresponding input current 121 supplied by the input voltage source 120 may be positive (see FIG. 5 between time T53 and time T55) or negative (between time T55 and time T57).

The polarity signal 413 (status feedback associated with the input current 121) indicates whether the input current 121 and/or corresponding input voltage supplied by the input voltage source 120 is currently positive or negative.

Based upon the received error signal 412 and the polarity signal 413, the signal converter function 421 produces the offset adjustment value 425 outputted to the multiplier function 435. In other words, in one example, via a lookup table, the signal converter function 422 can be configured to map the magnitude of the error signal 412 into a magnitude adjustment value 425.

Note that the signal converter function 421 can be implemented in any suitable manner. In one example, the signal converter function 421 can be configured to include a lookup table to convert the error signal 412 into the respective current magnitude adjustment value 426. The magnitude adjustment value 426 (a.k.a., MAV) generated by the signal converter function 421 indicates an amount by which to modify the reference current value 428 (a.k.a., Iac_ref). The reference current value 428 may be a selected setting or fixed setting.

In one example, the reference current value 428 is a reference or setpoint value to control a magnitude of current supplied to the resonant power converter 100 and corresponding inductor L1 during conditions in which the magnitude of the voltage CV1 substantially equals the magnitude of the voltage CV2.

As previously discussed in FIG. 3, in other FIGS., the magnitude of the input current 121 supplied by the input voltage source 120 (input current source) is susceptible to variations and inconsistencies. This may result in the magnitude of the voltage Vsplit being for drifting to a value other than Vbus/2. When the magnitude of the voltage Vsplit equals Vbus/2, the magnitude of the error signal 412 is zero and the magnitude adjustment value 426 is set to 0. In such an instance, the reference current value 428-1 is equal to the reference current value 428.

The offset adjustment value 426 is a nonzero value during conditions in which the magnitude of the error signal 412 is greater than or less than 0. This corresponds to conditions which the magnitude of the voltage Vsplit does not equal the magnitude of the voltage Vref (Vbus/2) or the magnitude of voltage falls out a desired voltage range.

The generated magnitude adjustment value 426 is used to adjust the reference current value 428 in order to regulate the magnitude of the voltage Vsplit such that the voltage Vsplit is equal to Vbus/2, resulting in the magnitude of the voltage CV1 across capacitor C1 being substantially equal to a magnitude of the voltage CB to across capacitor C2.

For example, as its name suggests, the multiplier function 435 multiplies the reference current value 428 (nominal) by the magnitude adjustment value 426 to produce the corresponding adjusted current reference value 428-1 (a.k.a., Iac_ref_new). The adjusted offset current reference value 428-1 is supplied to the signal generator 440 and is used as a basis in which to adjust the switch control signal S1 (controlling switch Q1) and the switch control signal S2 (controlling switch Q2). This is further shown in FIGS. 5-7.

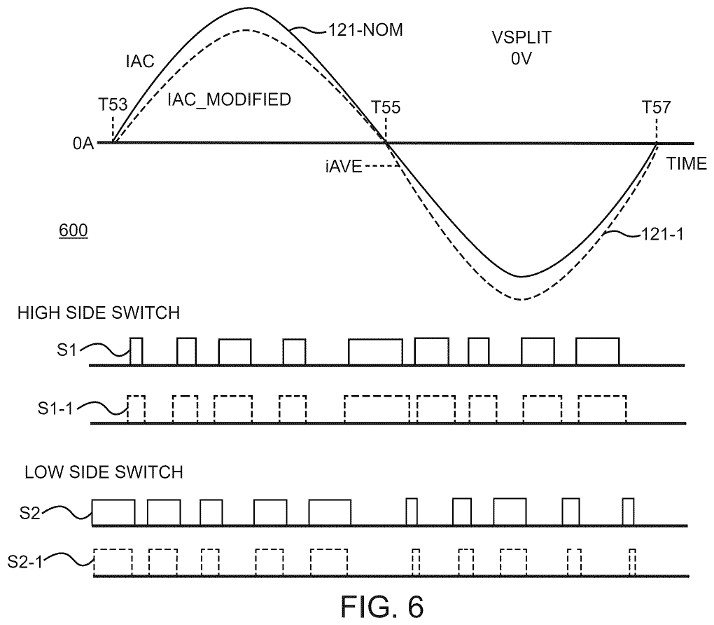

Referring again to FIG. 4, as an example, the error signal 412 may indicate a magnitude of error such as +10 volts between Vsplit (such as 210) and Vref (such as 200). Via a lookup table or other converter function, for a positive part (positive polarity) of the cycle between T53 and T55, the signal converter function 421 can be configured to map the value of +10 volts to a magnitude adjustment value of 0.9. The multiplier function 435 multiplies the reference current value 428 by the magnitude adjustment value 426 of 0.9 to produce the reference current value 428-1 for adjusting signals S1 and S2 between time T53 and time T55 (see FIG. 6). In one example, the magnitude adjustment value 426 may be used to proportionally adjust ON-times or OFF-times of a respective duty cycle of control signals S1 and S2.

As another example, the error signal 412 may indicate a magnitude of error such as +10 volts between Vsplit (such as 210) and Vref (such as 200). Via a lookup table or other converter function, for a negative part (negative polarity) of the cycle between T55 and T57, the signal converter function 421 can be configured to map the value of +10 volts to a magnitude adjustment value of 1.1. The multiplier function 435 multiplies the reference current value 428 by the magnitude adjustment value 426 of 1.1 to produce the reference current value 428-1 for adjusting signals S1 and S2 between time T55 and time T57 (see FIG. 6). As previously discussed, the magnitude adjustment value 426 may be used to proportionally adjust ON-times or OFF-times of a respective duty cycle of control signals S1 and S2.

Adjustment of the switch control signals S1 and S2 adjusts the magnitude of the input current 121 through the inductor L1 during one or more portions of an input current cycle such that the magnitude of the respective voltages across the respective capacitors C1 and C2 become substantially equal.

Thus, as discussed herein, adjustment of the magnitude of the input current 121 includes the controller 140: receiving the voltage Vsplit; producing an error signal 412 based on a difference between the voltage Vsplit and a reference voltage value Vref (such as VBUS/2 or other suitable threshold or setpoint reference); implementing a signal converter function 421 such as a lookup table or other suitable entity such as equations to convert the error signal 412 into an magnitude adjustment value 426; implementing a multiplier function 435 to adjust a reference current value 428 via the magnitude adjustment value 426 to produce the adjusted reference current value 428-1 (a.k.a., signal); and using the adjusted reference current value 428-1 as a basis to adjust the magnitude of the input current 121 over one or more positive or negative polarities of input voltage source 121 (input current source) supplying the input current 121.

FIG. 5 is an example timing diagram illustrating a first method (amplitude modulation) of adjusting input current to a power converter to regulate a respective capacitor voltage as discussed herein.

As previously discussed, the magnitude of the input current 121 varies over time and may be inconsistent such as a non-sine wave. For example, as shown in timing diagram 502, between time T51 and time T52, the polarity of the input current 121 is positive.

The input voltage source 120 experiences a respective glitch of supplying input current 121 and corresponding input voltage between time T52 and time T53, where the magnitude of the input current 121 is 0.

Between time T53 and time T57, control of the input current 121 by the controller 140 would normally be a respective cycle or portion of a sine wave as illustrated by nominal input current 121. However, at or around time T53, the magnitude of the error voltage 412 becomes greater than the voltage Vref based on the input current 121 reduction between time T52 and time T53. In such an instance, as previously discussed, the multiplier function 435 produces the adjusted reference current value 428-1, resulting in adjustment of a magnitude of the input current 121 into the inductor L1 as shown by adjusted input current 121-1 (decrease in an amplitude of the current 121 to input current 121-1 during the positive polarity cycle portion between time T53 and time T55 and increase in the amplitude of the input current 121 to input current 121-1 during the negative polarity between time T55 and time T57) as shown in FIG. 5.

Thus, in one example, the average input current 121 (such as iAVE) for a positive portion and a negative portion of a respective input current cycle would normally be 0. However, in this example, in response to detecting that the magnitude of the error signal 412 (such as error voltage is greater than 0), the controller 140 controls the switches Q1 and Q2 to decrease the average magnitude of the input current 121 (iAVE) between time T53 and time T57 (see IbalL and IbalH and input current 121-1). Accordingly, via the adjusted reference current 428 to reference current 428-1, the controller 140 can be configured to operate switches Q1 and Q2 to decrease the magnitude of the input current 121 such as between time T53 and time T55 in response to detecting that the magnitude of the voltage Vsplit is above a threshold level (Vref). The controller 140 can be configured to operate switches Q1 and Q2 to increase the magnitude of the input current 121 such as between time T55 and time T57 (negative portion of the cycle) in response to detecting that the magnitude of the voltage Vsplit is above a threshold level (Vref). An example of how to adjust the input current 121 to provide regulation is further discussed in timing diagram 600 of FIG. 6.

FIG. 6 is a timing diagram illustrating regulation of an intermediate voltage (such as split capacitor voltage Vsplit) via pulse width modulation adjustments as discussed herein.

One way to adjust the amplitude of the input current 121 for a positive or negative cycle is to change the duty of controlling the respective switches Q1 and Q2 as shown in timing diagram 600.

As previously discussed, the adjusted change in the magnitude of input current 121-1 results in regulating the magnitude of the voltage Vsplit. In other words, between time T53 and time T55, the increase in the duty cycle of controlling the switch Q1 from control signal S1 to control signal S1-1 (where signal S1-1 has a greater duty cycle than the nominal signal S1) and decrease in the duty cycle of controlling the switch Q2 from control signal S2 to control signal S2-1 (where signal S2-1 has a lower duty cycle than the nominal signal S2) results in adjusted input current 121-1 (as controlled by the adjusted reference current value 428-1 to iAVE<0) supplied to the inductor L1 instead of nominal current 121-NOM through the inductor L1. Application of the adjusted input current 121-1 (iAC-ADJ) causes the magnitude of the voltage Vsplit to be nearer to the voltage Vbus/2, balancing capacitor voltages associated with capacitor C1 and capacitor C2. In this example, assume that the error signal 412 is greater than the reference voltage Vref as previously discussed. In such an instance, the multiplier function 435 adjusts the magnitude of the reference current value 428-1 such that control signal generator 440 associated with the controller 142 decreases input current 121 from the magnitude of the nominal input current 121-NOM (generated via control signal S1 and S2) to the adjusted input current 121-1 with reduced amplitude between time T53 and time T55 and increased negative amplitude between time T55 and time T57 via generation of the control signal S1-1 driving switch Q1 and control signal S2-1 driving switch Q2.

Thus, as previously discussed, based on the adjusted reference current value 428-1 for the positive portion and the negative portion of the input current 121, to achieve this reduced amplitude in the positive portion of the cycle between time T53 and time T55, the controller 140 produces the control signal S1-1 with an increased duty cycle (compared to nominal control signal S1) to drive the switch Q1; the controller 140 produces the control signal S2-1 (compared to nominal control signal S2) with a decreased duty cycle to control the switch Q2.

After time T57, when the error voltage 412 reduces to 0 again after the magnitude of the voltage Vsplit becomes Vbus/2 based on the current adjustment, the controller 140 reverts back to controlling the respective switches Q1 and Q2 with duty cycles associated with nominal signals S1 and S2 providing the nominal current 121-NOM again.

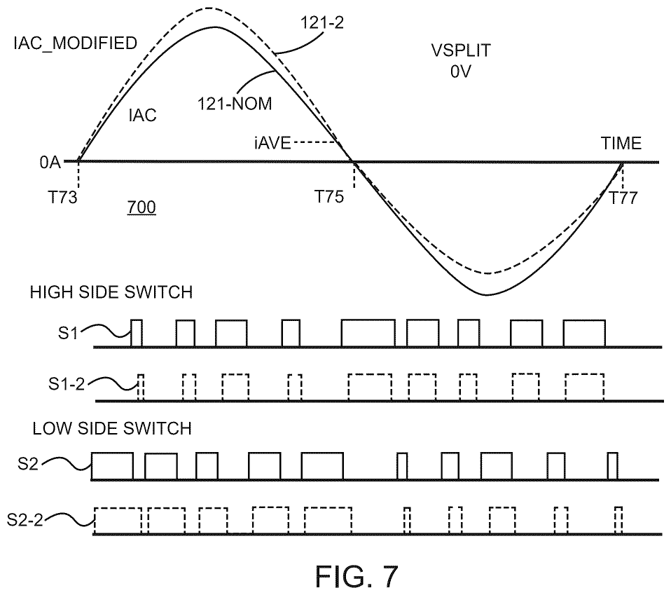

FIG. 7 is an example timing diagram illustrating a second method (DC offset adjustment) of adjusting input current to a power converter to regulate a respective capacitor voltage as discussed herein.

As previously discussed, one way to adjust the amplitude of the input current 121 for a positive or negative cycle is to change the duty cycles of controlling the respective switches Q1 and Q2.

In this example, assume that the error signal 412 is detected as being less than the reference voltage Vref at or around time T73. In such an instance, the multiplier function 435 adjusts the magnitude of the reference current 428 to reference current value 428-1 (to increase an average magnitude of input current 121-NOM such that iAVE>0 for the input current 121-2) such that control signal generator 440 associated with the controller 140 increases the input current 121 with respect to the magnitude of the nominal input current 121-NOM (generated via control signal S1 and S2) to produce the input current 121-2 with increased amplitude for every instance of the input current signal between time T73 and time T75 via generation of the control signal S1-2 driving switch Q1 and control signal S2-2 driving switch Q2. Thus, to achieve this increased amplitude of the input current 121, the controller 140 produces the control signal S1-2 with a decreased duty cycle with respect to signal S1 to drive the switch Q1 resulting in input current 121-2 between time T73 time T75; the controller 140 produces the control signal S2-1 with an increased duty cycle with respect to signal S2 to control the switch Q2 resulting in input current 121-2 between time T75 and time T77.

After time T57, when the error voltage 412 reduces to zero again after the magnitude of the voltage Vsplit=Vbus/2, the controller 140 reverts back to controlling the respective switches Q1 and Q2 with signals S1 and S2 providing the nominal current 121-NOM again because there is no undervoltage or overvoltage condition associated with the voltage Vsplit.

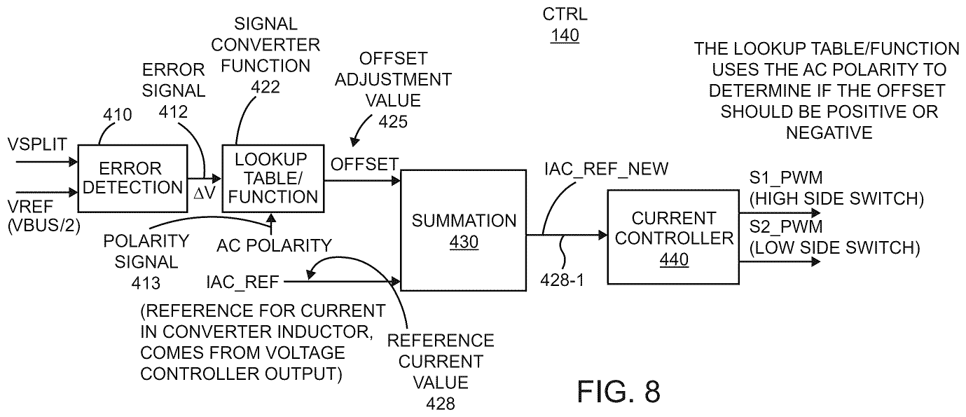

FIG. 8 is an example diagram illustrating adjustment of a reference current value to regulate the power converter as discussed herein.

In this example, the controller 140 includes error signal generator 410, signal converter function 422, summer 430, and PWM (Pulse Width Modulation) signal generator 440.

As shown, the error signal generator 410 can be configured to receive the voltage Vsplit generated at the node N5. Additionally, the error signal generator 410 receives the setpoint reference voltage Vref (such as Vbus/2 or other suitable value).

The error signal generator 410 (such as error detection circuitry) produces the respective error signal 412 indicating a respective difference between the magnitude of the voltage Vsplit and the magnitude of the setpoint reference voltage Vref. The error signal generator 410 outputs the error signal 412 to the signal converter function 422.

As previously discussed, the input voltage and corresponding input current 120 supplied by the input voltage source 120 may be positive or negative. The signal 413 indicates whether the input current 121 is currently positive or negative.

Based upon the received air signal 412 and the polarity signal 413, the signal converter function 422 produces the offset adjustment value 425 supplied to the summer 430. In other words, via a lookup table, the signal converter function 422 can be configured to map the magnitude of the error signal 412 into an offset adjustment value 425.

Note that the signal converter function 422 can be implemented in any suitable manner. In one example, the signal converter function 422 includes a lookup table for equation to convert the error signal 412 into the respective offset adjustment value 425. In other words, via a lookup table, the signal converter function 422 can be configured to map the magnitude of the error signal 412 into an active offset adjustment value 425. The offset adjustment value 425 (OAV) indicates an amount by which to modify the reference current value 428 (Iac_ref) to produce the adjusted reference current value 428-1. Note that the adjusted reference current value 428-1 may be equal to the reference current value 428 during conditions in which the offset adjustment value is 0.

In one example, the reference current value 428 is a reference or setpoint value to control a magnitude of current supplied to the resonant power converter 100 and corresponding inductor L1.

As previously discussed in FIG. 3, the magnitude of the input current 121 supplied by the input voltage source 120 (input current source) is susceptible to variations and inconsistencies. This may result in the magnitude of the voltage Vsplit being a value other than Vbus/2.

Referring again to FIG. 8, the generated offset adjustment value 425 is used to adjust the reference current value 428 in order to regulate the magnitude of the voltage Vsplit such that it is equal to Vbus/2, resulting in the magnitude of the voltage CV1 across capacitor C1 being substantially equal to a magnitude of the voltage CB to across capacitor C2.

For example, as its name suggests, the summer 430 sums the reference current value 428 and the offset adjustment value 425 (offset) to produce the corresponding adjusted offset current reference value 428-1 (a.k.a., Iac_ref_new).

The adjusted offset current reference value 428-1 is supplied to the signal generator 440 and is used as a basis in which to adjust the switch control signal S1 (controlling switch Q1) and switch control signal S2 (controlling switch Q2). This is further shown in FIGS. 5-7.

Referring again to FIG. 8 adjustment of the switch control signals S1 and S2 adjusts the magnitude of the input current 121 through the inductor L1 during one or more portions of the input current cycle such that the magnitude of the respective voltages across this the respective capacitors C1 and C2 becomes substantially equal.

Thus, as discussed herein, adjustment of the magnitude of the input current 121 includes the controller 140: receiving the voltage Vsplit; producing an error signal 412 based on a difference between the voltage Vsplit and a reference voltage value Vref; implementing a signal converter function 422 such as a lookup table or other suitable entity such as equations to convert the error signal 412 into an offset adjustment value 425; implementing a summer function 430 to adjust a reference current value 428 via the offset adjustment value 425 to produce the adjusted reference current value 428-1 (a.k.a., signal); and using the adjusted reference current value 428-1 as a basis to adjust the magnitude of the input current 121 over one or more positive or negative polarities of input voltage source 121 (input current source) supplying the input current 121.

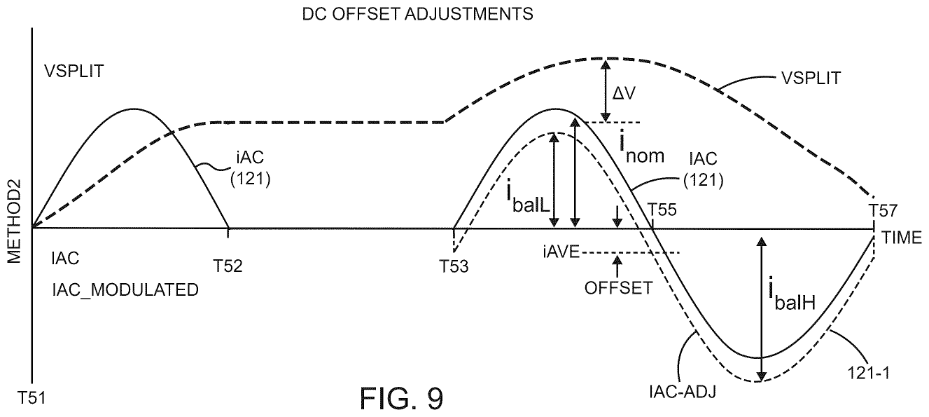

FIG. 9 is an example timing diagram illustrating a first method (amplitude modulation) of adjusting input current to a power converter to regulate a respective capacitor voltage as discussed herein.

As previously discussed, the magnitude of the input current 121 varies over time and may be inconsistent such as a non-sine wave. For example, between time T51 and time T52, the polarity of the input current 121 is positive. The input voltage source 120 experiences a respective glitch of supplying input current and corresponding input voltage between time T52 and time T53, where the magnitude of the input current 121 is 0 or some other improper amount.

Between time T53 and time T57, control of the input current 121 by the controller 140 would normally be a respective cycle or portion of a sine wave as illustrated by nominal input current 121. However, at or around time T53, the magnitude of the error voltage 412 becomes greater than the voltage Vref. In such an instance, as previously discussed, the multiplier function 435 produces the adjusted reference current value 428-1, resulting in adjustment of a magnitude of the input current 121 into the inductor L1 as shown by adjusted input current 121-1 (DC offset decreasing an amplitude of the current 121 during the positive polarity cycle portion between time T53 and time T55 and increase in the amplitude of the input current 121 during the negative polarity between time T55 and time T57) as shown in FIG. 9.

Thus, in one example, the average input current 121 for a positive portion and a negative portion of a respective input current cycle would normally be 0. However, in this example, in response to detecting that the magnitude of the error signal 412 (such as error voltage is greater than 0), the controller 140 controls the switches Q1 and Q2 to decrease the average magnitude of the input current 121 (iAVE) between time T53 and time T57. Accordingly, the controller 140 can be configured to operate switches Q1 and Q2 to decrease the magnitude of the input current 121 such as between time T53 and time T55 in response to detecting that the magnitude of the voltage Vsplit is above a threshold level (Vref). The controller 140 can be configured to operate switches Q1 and Q2 to increase the negative magnitude of the input current 121 such as between time T55 and time T57 (negative portion of the cycle) in response to detecting that the magnitude of the voltage Vsplit is above a threshold level (Vref) such as when the error voltage is greater than 0.

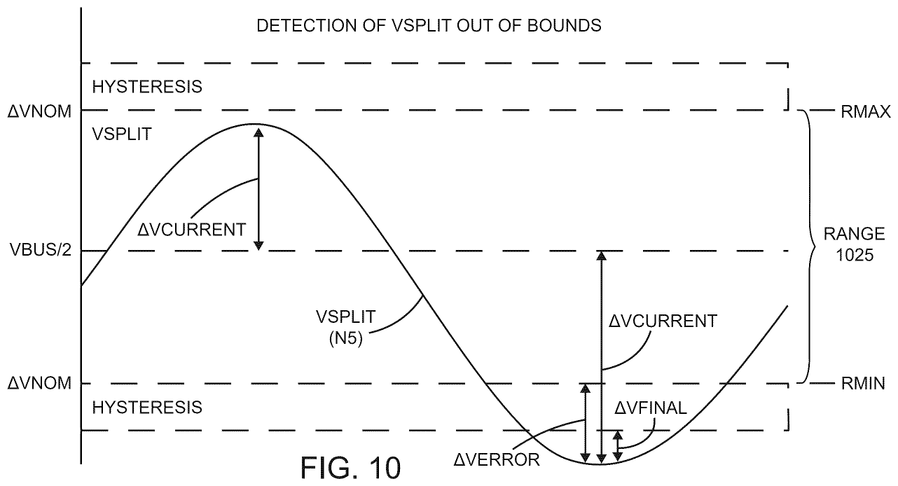

FIG. 10 is an example diagram illustrating a range in which to regulate the magnitude of an intermediate voltage (a.k.a., Vsplit) of a resonant power converter as discussed herein.

As previously discussed, the controller 140 can be configured to monitor a magnitude of the voltage Vsplit at node N5. It is desirable to maintain a magnitude of the monitored voltage Vsplit to be within a respective range such as range 1025 defined by Rmax and Rmin.

Thus, in one example, the first capacitor C1 is directly connected between the node N1 and node N5 of the resonant power converter 100; the second capacitor C2 is directly connected between the node N5 and node N2 of the resonant power converter 100. The controller 140 can be configured to regulate the magnitude of the input current 121 to maintain the magnitude the voltage Vsplit within a desired voltage range 1025.

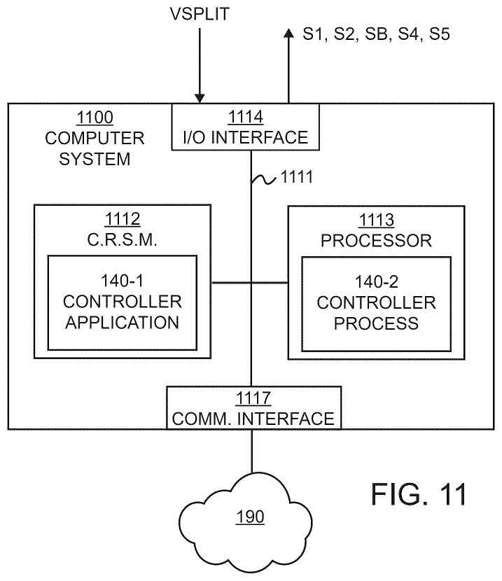

FIG. 11 is an example block diagram of a computer system for implementing any of the operations as previously discussed according to examples herein.

Note that any of the resources (such as controller 140, etc.) as discussed herein can be configured to include computer processor hardware and/or corresponding executable instructions to carry out the different operations as discussed herein.

For example, as shown, computer system 1150 of the present example includes interconnect 1111 coupling computer readable storage media 1112 such as a non-transitory type of media or any suitable type of computer readable hardware storage in which digital information can be stored and or retrieved, a processor 1113 (computer processor hardware), I/O interface 1114, and a communications interface 1117.

I/O interface(s) 1114 supports connectivity to repository 1180 and input resource 1192.

Computer readable storage medium 1112 can be any hardware storage device such as memory, optical storage, hard drive, floppy disk, etc. In one example, the computer readable storage medium 1112 stores instructions and/or data.

As shown, computer readable storage media 1112 can be encoded with controller application 140-1 (e.g., including instructions) in a respective wireless station to carry out any of the operations as discussed herein.

During operation of one example, processor 1113 accesses computer readable storage media 1112 via the use of interconnect 1111 in order to launch, run, execute, interpret or otherwise perform the instructions in controller application 140-1 stored on computer readable storage medium 1112. Execution of the controller application 140-1 produces controller process 140-2 to carry out any of the operations and/or processes as discussed herein.

Those skilled in the art will understand that the computer system 1150 can include other processes and/or software and hardware components, such as an operating system that controls allocation and use of hardware resources to execute the controller application 140-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1150 may reside at any location or can be included in any suitable resource in any network environment to implement functionality as discussed herein.

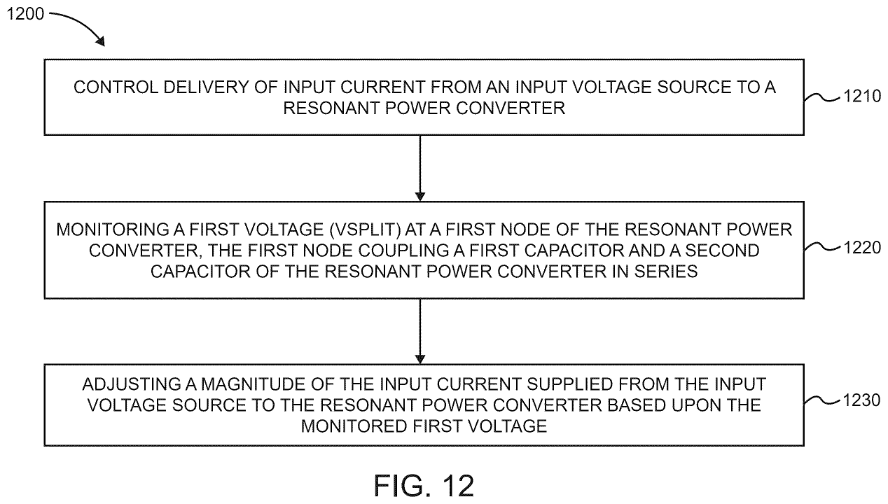

Functionality supported by the different resources will now be discussed via flowcharts in FIG. 12. Note that the steps in the flowcharts below can be executed in any suitable order.

FIG. 12 is a flowchart 1200 illustrating an example method according to examples herein. Note that there will be some overlap with respect to concepts as discussed above.

In processing operation 1210, the controller 140 controls delivery of (AC) input current 121 from an input voltage source 120 to the resonant power converter 100.

In processing operation 1220, the controller 140 monitors voltage Vsplit at node N5 of the resonant power converter 100. The node N5 couples the capacitor C1 and capacitor C2 of the resonant power converter 100 in series.

In processing operation 1230, the controller 140 adjusts a magnitude of the input current 121 supplied from the input voltage source 120 to the resonant power converter 100 based upon the monitored voltage Vsplit.

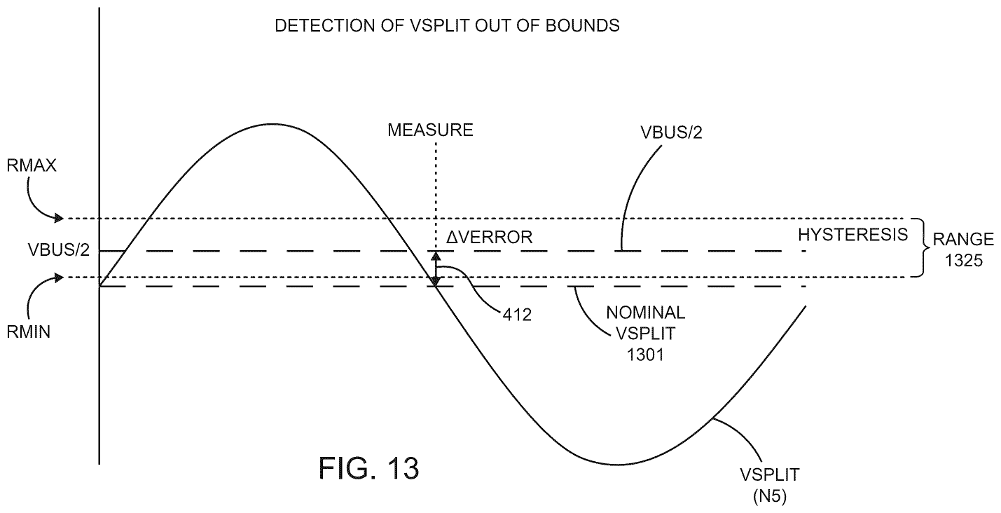

FIG. 13 is an example diagram illustrating detection of the intermediate voltage (such as voltage Vsplit) being out of range as discussed herein.

In this example, the average magnitude of the voltage Vsplit as measured at node N5 for one or more cycles is voltage 1301. In one example, the error voltage (such as error signal 412) as produced by the difference function 410 is the difference between Voltage bus/2 (Vref) and the voltage 1301 (Vsplit) which falls outside the acceptable range 1325 as defined by the range maximum voltage Rmax and range minimum voltage Rmin associated with the voltage Vbus/2.

In a manner as previously discussed, because the magnitude of the voltage 1301 falls outside of the range 1325, the controller 140 adjusts the operation of the switch Q1 and switch Q2 in order to maintain an average magnitude of the voltage Vsplit to fall within the range 1325.

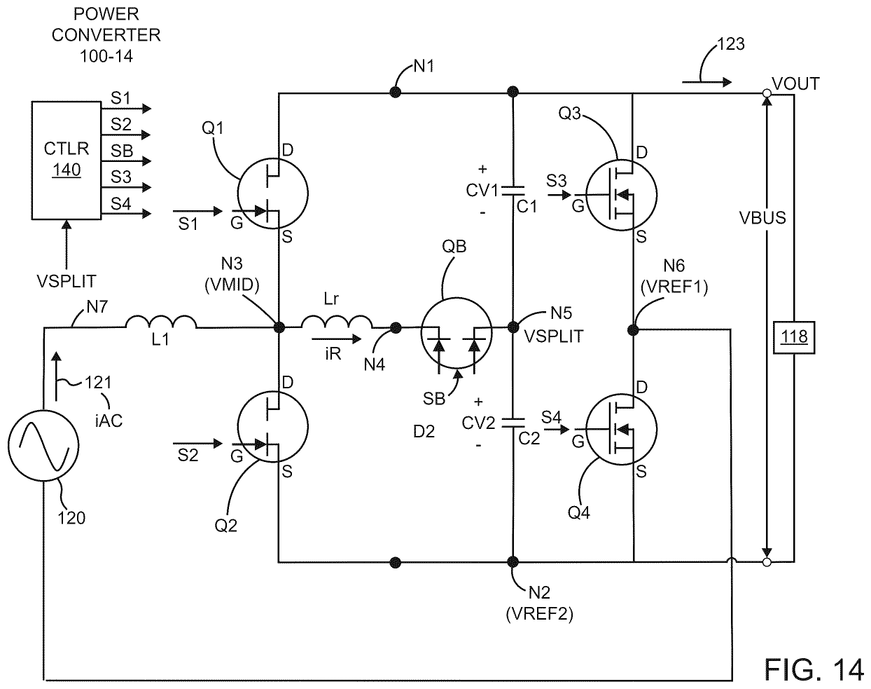

FIG. 14 is an example circuit diagram illustrating implementation of a power converter as discussed herein.

The example power converter 100-14 is similar to the power converter 100 in FIG. 1 except that the power converter 100-14 does not include the diode D1 and diode D2. The power converter 100-14 operates in a similar manner as power converter 100 but without the diode D1 and the diode D2.

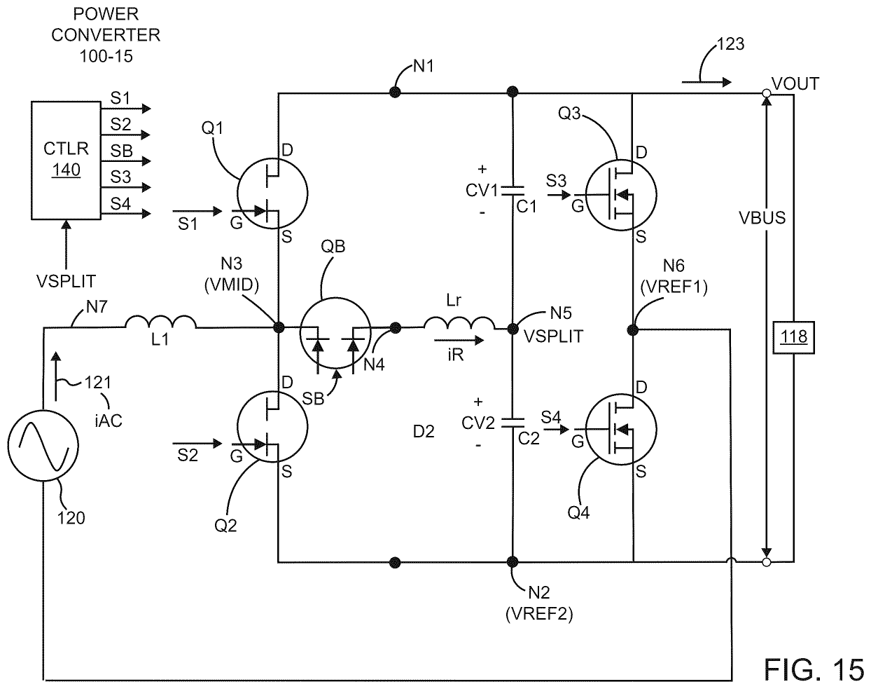

FIG. 15 is an example circuit diagram illustrating implementation of a power converter as discussed herein.

The example power converter 100-15 is similar to the power converter 100-14 in FIG. 14 except that the placement of the inductor Lr and the placement of the switch QB are swapped.

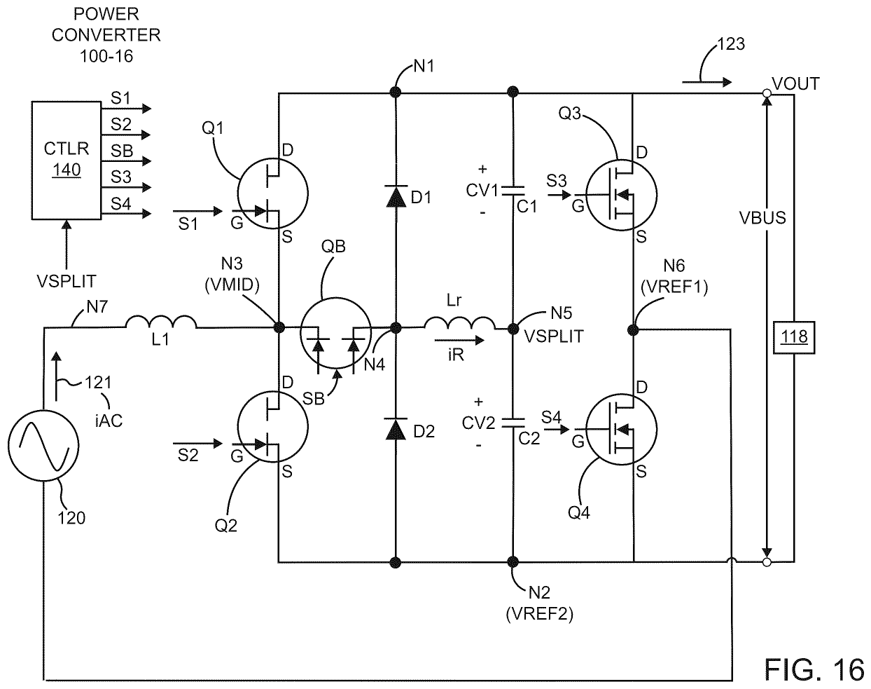

FIG. 16 is an example circuit diagram illustrating implementation of a power converter as discussed herein.

The example power converter 100-16 is similar to the power converter 100 in FIG. 1 except that the placement of the inductor Lr and the placement of the switch QB are swapped.

Note again that techniques herein are well suited for use in circuit applications such as resonant power converters with split capacitors. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

1. A method comprising:
controlling delivery of input current from an input voltage source to a resonant power converter;
monitoring a first voltage at a first node of the resonant power converter, the first node coupling a first capacitor and a second capacitor of the resonant power converter in series; and
adjusting a magnitude of the input current supplied from the input voltage source to the resonant power converter based upon the monitored first voltage.

2. The method as in claim 1 further comprising:
via the adjusted magnitude of the input current, regulating a magnitude of the first voltage.

3. The method as in claim 2, wherein adjusting the magnitude of the input current includes:
controlling operation of first switches, the controlled operation of the first switches controlling supply of the input current through an inductor of the resonant power converter.

4. The method as in claim 1, wherein the first capacitor is directly connected between the first node and a second node of the resonant power converter;
wherein the second capacitor is directly connected between the first node and a third node of the resonant power converter, the method further comprising:
controlling the magnitude of the input current to maintain the magnitude of the first voltage within a desired voltage range.

5. The method as in claim 4, wherein the first capacitor stores a first capacitor voltage;
wherein the second capacitor stores a second capacitor voltage; and
the method further comprising: adjusting the magnitude of the input current from the input voltage source to the resonant power converter such that a magnitude of the first capacitor voltage is substantially equal to a magnitude of the second capacitor voltage.

6. The method as in claim 4, wherein the resonant power converter outputs an output voltage from a combination of the second node and the third node; and
wherein adjusting the magnitude of the input current maintains a magnitude of the first voltage to be substantially half the magnitude of the output voltage.

7. The method as in claim 1, wherein the input current is an AC input current supplied by the input voltage source to the resonant power converter; and
wherein the resonant power converter is operative to convert the AC input current into a DC output voltage.

8. The method as in claim 1, wherein adjusting the magnitude of the input current supplied from the input voltage source includes adjusting pulse width modulation control signals supplied to high side switch circuitry and low side switch circuitry of the resonant power converter.

9. The method as in claim 8, wherein adjusting the pulse width modulation control signals includes:
in response to detecting that a magnitude of the first voltage is above a threshold level, operating the resonant power converter in a first mode of: i) increasing a first duty cycle of operating the first switch circuitry, and ii) decreasing a second duty cycle of operating the second switch circuitry, operation in the first mode reducing the magnitude of the first voltage; and
in response to detecting that a magnitude of the first voltage is below a threshold level, operating the resonant power converter in a second mode of: i) decreasing a first duty cycle of operating the first switch circuitry, and ii) increasing a second duty cycle of operating the second switch circuitry, operation in the second mode increasing the magnitude of the first voltage.

10. The method as in claim 1, wherein adjusting the magnitude of the input current includes:
decreasing an average magnitude of the input current in response to detecting that the magnitude of the first voltage is above a threshold level.

11. The method as in claim 1, wherein adjusting the magnitude of the input current includes:
increasing an average magnitude of the input current in response to detecting that the magnitude of the first voltage is below a threshold level.

12. The method as in claim 1 further comprising:
receiving an error voltage indicating a difference between the magnitude of the first voltage and a setpoint reference voltage; and
adjusting the magnitude of the input current supplied from the input voltage source to the resonant power converter based on a magnitude of the error voltage.

13. The method as in claim 1, wherein adjusting the magnitude of the input current includes:
receiving an error value indicating a difference between a magnitude of the first voltage and a setpoint reference value;
implementing a lookup table to convert the error value into an adjustment value; and
adjusting the magnitude of the input current based upon the adjustment value.

14. The method as in claim 13, wherein adjusting the magnitude of the input current based on the adjusted value includes:
implementing a summer function to adjust a reference current value via the adjusted value; and
using the adjusted reference current value as a basis to adjust the magnitude of the input current.

15. The method as in claim 13, wherein adjusting the magnitude of the input current based on the adjusted value includes:
implementing a multiplier function to adjust a reference current value via the adjusted value; and
using the adjusted reference current value as a basis to adjust the magnitude of the input current.

16. An apparatus comprising:
a controller operative to:
control delivery of input current from an input voltage source to a resonant power converter;
monitor a first voltage at a first node of the resonant power converter, the first node coupling a first capacitor and a second capacitor in series; and
adjust a magnitude of the input current supplied from the input voltage source to the resonant power converter based upon the monitored first voltage.

17. The apparatus as in claim 16, wherein the controller is further operative to:
regulate a magnitude of the first voltage via the adjusted magnitude of the input current supplied from the input voltage source to the resonant power converter.

18. The apparatus as in claim 16, wherein the first capacitor is directly connected between the first node and a second node of the resonant power converter;
wherein the second capacitor is directly connected between the first node and a third node of the resonant power converter, the method further comprising:
wherein the controller is further operative to regulate the magnitude of the input current to maintain the magnitude of the first voltage within a desired voltage range.

19. The apparatus as in claim 18, wherein the first capacitor stores a first capacitor voltage;
wherein the second capacitor stores a second capacitor voltage; and
wherein the controller is further operative to adjust the magnitude of the input current from the input voltage source to the resonant power converter such that a magnitude of the first capacitor voltage is substantially equal to a magnitude of the second capacitor voltage.

20. The apparatus as in claim 18, wherein the resonant power converter is operative to output an output voltage from a combination of the second node and the third node; and
wherein the controller is further operative to adjust the magnitude of the input current maintains a magnitude of the first voltage to be substantially half the magnitude of the output voltage.
